(19) United States
(12) Patent Application Publication
(10) Pub. No.: US 2024/0201872 A1
(43) Pub. Date: Jun. 20, 2024

(54) STORAGE SYSTEM, DATA TRANSFER CONTROL METHOD, AND DATA TRANSFER CONTROL PROGRAM

(71) Applicant: Hitachi, Ltd., Tokyo (JP)

(72) Inventors: Mitsuo HAYASAKA, Tokyo (JP); Yuto KAMO, Tokyo (JP)

(73) Assignee: Hitachi, Ltd., Tokyo (JP)

(21) Appl. No.: 18/461,715

(22) Filed: Sep. 6, 2023

(30) Foreign Application Priority Data
Dec. 14, 2022 (JP) 2022-199528

(51) Int. Cl. G06F 3/06

(52) U.S. Cl. CPC G06F 3/0622; G06F 3/0655; G06F 3/067

(57) ABSTRACT

A control method transfers data to a site in another region having a different regulation related to sensitive data in a storage system. When receiving an instruction to transfer a predetermined memory area unit stored in a storage apparatus to another storage apparatus located in another region, the storage system determines, with reference to data transfer availability information in which sensitive data and a transfer permission and rejection region of the sensitive data are associated with each other, whether a transfer destination according to the transfer instruction is included in the transfer permission and rejection region associated with the sensitive data stored in the predetermined memory area unit according to the transfer instruction. The storage system performs or prevents transfer of the predetermined memory area unit to another storage apparatus according to a determination result of whether the transfer destination is included in the transfer permission and rejection region.

### BACKGROUND OF THE INVENTION

### 1. Field of the Invention

The present invention relates to a storage system, a data transfer control method, and a data transfer control program.

### 2. Description of Related Art

In recent years, a system has appeared, which shares data provided at each distributed site among sites or uses data provided at another site, such as a hybrid cloud environment or a multi-cloud environment (for example, see JP2022-123774A).

### CITATION LIST

### Patent Literature

PTL 1: JP2022-123774A

### SUMMARY OF THE INVENTION

The data stored at each site may include so-called sensitive data related to personal privacy, state secret, or the like. The sensitive data is subjected to regulations (for example, general data protection regulation (GDPR) or California consumer privacy act (CCPA)) for each region located with each site, and data movement to another region is regulated. Under such circumstances, in the storage system, there is a problem of how to control data transfer when sites of a data transfer source and a data transfer destination are regions having different regulations related to sensitive data.

The invention has been made in view of the above-described background, and an object thereof is to provide a control method for transferring data to a site in another region having a different regulation related to sensitive data in the storage system.

An aspect of the invention provides a storage system including a storage apparatus for storing data. The storage system includes: a processor; and a memory unit configured to store data transfer availability information in which sensitive data and a transfer permission and rejection region of the sensitive data are associated with each other. When receiving a transfer instruction to transfer a predetermined memory area unit stored in the storage apparatus to another storage apparatus located in another region different from a region located with the storage apparatus, the processor determines, with reference to the data transfer availability information, whether a transfer destination according to the transfer instruction is included in the transfer permission and rejection region that is associated with the sensitive data stored in the predetermined memory area unit according to the transfer instruction, and performs or prevents transfer of the predetermined memory area unit to the other storage apparatus according to a determination result of whether the transfer destination is included in the transfer permission and rejection region.

According to one aspect of the present application, it is possible to provide a control method for transferring data to a site in another region having a different regulation related to sensitive data in the storage system.

### BRIEF DESCRIPTION OF THE DRAWINGS

FIG. 1 is a diagram illustrating an outline of a first embodiment;

FIG. 2 is a diagram illustrating a configuration of a storage system according to the first embodiment;

FIG. 3 is a diagram illustrating a configuration of data transfer availability information according to the first embodiment;

FIG. 4 is a diagram illustrating a configuration of storage site region information according to the first embodiment;

FIG. 5 is transfer a flowchart illustrating data availability information creation processing according to the first embodiment;

FIG. 6 is a flowchart illustrating DB-Volume mapping information acquisition processing according to the first embodiment;

FIG. 7 is a flowchart illustrating data transfer processing according to the first embodiment;

FIG. 8 is a diagram illustrating a configuration of data transfer availability information according to a second embodiment;

FIG. 9 is a flowchart illustrating data transfer availability information creation processing according to the second embodiment;

FIG. 10 is a flowchart illustrating DB-path mapping information acquisition processing according to the second embodiment;

FIG. 11 is a flowchart illustrating data transfer processing according to the second embodiment ;

FIG. 12 is a diagram illustrating a configuration of data transfer availability information according to a third embodiment;

FIG. 13 is a flowchart illustrating data transfer availability information creation processing according to the third embodiment; and

FIG. 14 is a flowchart illustrating data transfer processing according to the third embodiment.

### DESCRIPTION OF EMBODIMENTS

Hereinafter, embodiments according to the disclosure in the application will be described with reference to the drawings. The embodiments are examples illustrating the application also including the drawings. In the embodiments, omission and simplification are appropriately made for clarified description. Unless otherwise specified, the number of components according to each embodiment may be singular or plural. An embodiment as a combination of one embodiment and another embodiment is also included in the embodiments according to the application.

The same or similar components are denoted by the same reference signs, and in the following embodiments and examples, the description thereof may be omitted, or only differences may be mainly described. When there are a plurality of the same or similar components, different subscripts may be attached to the same reference sign for description. In addition, when it is not necessary to distinguish the plurality of components, the description of the subscripts may be omitted. The number of components may be singular or plural unless otherwise specified.

In the embodiments, processing performed by executing programs may be described. A computer performs processing defined by a program while using a memory of a main memory device or the like by a processor (for example, a central processing unit (CPU) and a graphics processing unit (GPU)). Therefore, a subject of the processing performed by executing the program may be a processor. By executing the program by the processor, a functional unit that performs processing is implemented.

Similarly, the subject of the processing performed by executing the program may be a controller, a device, a system, a computer, or a node, each of which includes a processor. The subject of the processing performed by executing the program may be an arithmetic unit, and may include a dedicated circuit that performs specific processing. The dedicated circuit is, for example, a field programmable gate array (FPGA) or an application specific integrated circuit (ASIC).

The program may be installed in the computer from a program source. The program source may be, for example, a program distribution server or a computer-readable non-transitory memory medium. When the program source is the program distribution server, the program distribution server may include a processor and a memory resource (storage) that stores a program to be distributed, and the processor of the program distribution server may distribute the program to be distributed to another computer. In the embodiments, two or more programs may be implemented as one program, or one program may be implemented as two or more programs.

### FIRST EMBODIMENT

In a first embodiment, a database is constructed in a volume provided by a block storage apparatus at a certain site, and transfer of the volume to another site is controlled according to whether a table of a database stored in the volume includes sensitive data.

### Overview of First Embodiment

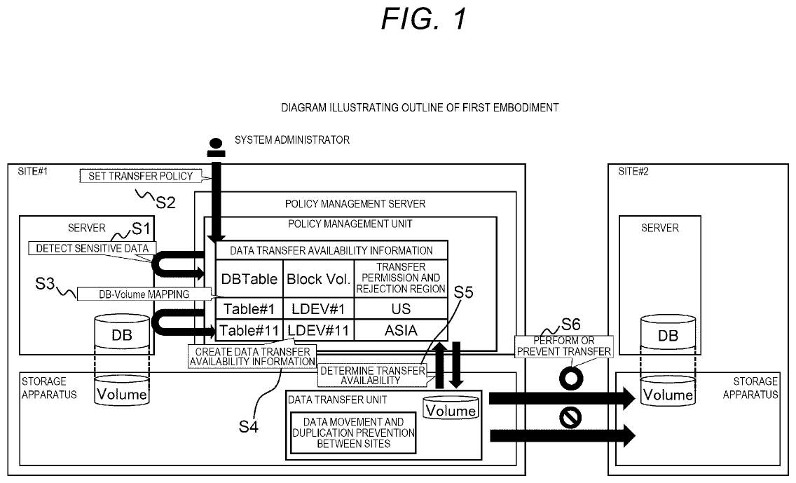

FIG. 1 is a diagram illustrating an outline of the first embodiment. Site #1 and site #2 illustrated in FIG. 1 are located in countries or regions having different laws or regulations related to handling of sensitive data. With reference to FIG. 1, an example will be described in which data transfer from a storage apparatus disposed at the site #1 to a storage apparatus disposed at the site #2 is permitted or prevented.

The site #1 is provided with a server, a storage policy, and a policy management server. In FIG. 1, the server at the site #1 is a database server that accesses the database constructed by mounting the volume provided by the storage apparatus, and the storage apparatus is a block storage. The database server is a server constructed on an on-premise virtual server or a cloud virtual server. The storage apparatus is an on-premise storage apparatus or a cloud storage apparatus.

At the site #1, first, in step S1, a policy management unit of the policy management server detects a database (DB) table including the sensitive data from a database stored in the storage apparatus. Next, in step S2, the policy management unit receives setting of a transfer policy by a system administrator for the DB table including the sensitive data detected in step S1. The transfer policy includes information indicating a country or region in which transfer of a DB table including sensitive data is permitted.

Next, in step S3, the policy management unit creates mapping information indicating correspondence between the DB table including the sensitive data detected in step S1 and the volume provided by the block storage in which the corresponding DB table is stored.

Next, step S4, the policy management unit Next, in associates the mapping information generated in step S3 with the transfer policy set in step S2 and creates data transfer availability information. When a DB table “Table #1” including the sensitive data is permitted to be transferred to the US, the policy management unit associates a transfer permission and rejection region “US” with mapping information on the DB table “Table #1” and a volume “LDEV #1”, and creates data transfer availability information.

In step S5, a data transfer unit of the storage apparatus inquires of the policy management server about transfer availability when a certain volume in a transfer unit is transferred to the site #2. The policy management server refers to the data transfer availability information according to the inquiry from the data transfer unit of the storage apparatus, determines whether the corresponding volume is transferable to the country or region at the site #2, and responds to the data transfer unit.

Next, in step S6, the data transfer unit transfers the corresponding volume to the site #2 when the policy management server responds that the corresponding volume is transferable to the country or region at the site #2. On the other hand, when the policy management server responds that the corresponding volume is untransferable to the country or region at the site #2, the data transfer unit prevents the transfer of the corresponding volume to the site #2.

In this manner, when the volume provided by the block storage is transferred to a site in a country or region having a different law or regulation related to handling of sensitive data, the transfer to a site of a transfer destination is permitted or prevented depending on whether the DB table including the sensitive data is stored.

### Configuration of Storage System S according to First Embodiment

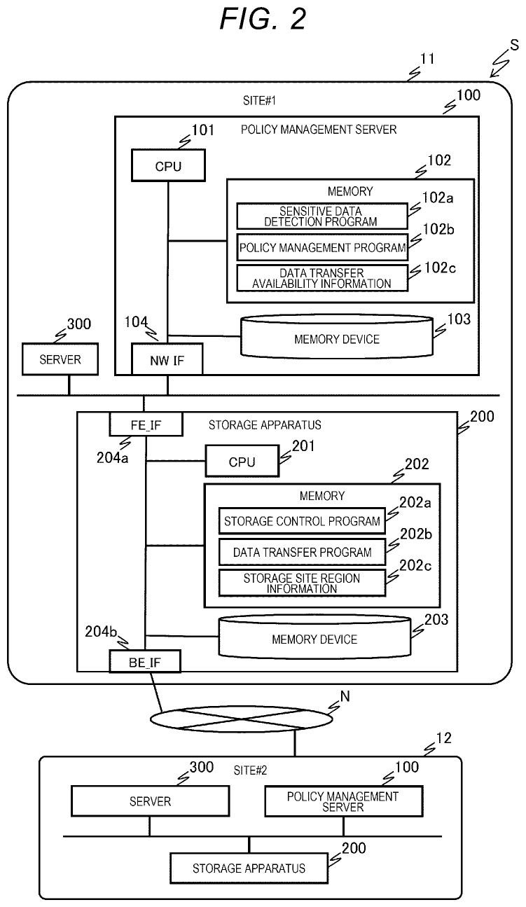

FIG. 2 is a diagram illustrating a configuration of a storage system S according to the first embodiment. In the storage system S, a plurality of sites including a site 11 (site #1) and a site 12 (site #2) are communicably connected via a network N. The site 11 is implemented by communicably connecting a policy management server 100, a storage apparatus 200, and a server 300. The site 12 and another site include at least the storage apparatus 200.

The server 300 is a physical server, or a hypervisor-type or container-type virtual server, and a database server operates therein. The storage apparatus 200 is a block storage and provides a volume for the server 300. The server 300 and the storage apparatus 200 may be on-premise or on the cloud.

### Configuration of Policy Management Server 100 According to First Embodiment

As illustrated in FIG. 2, the policy management server 100 includes a CPU 101, a memory 102, a memory device 103, and a network interface (IF) 104. The memory 102 stores a sensitive data detection program 102a, a policy management program 102b, and data transfer availability information 102c.

The sensitive data detection program 102a is executed by the CPU 101 that cooperates with the memory 102 and the memory device 103, so that a sensitive data detection unit is implemented. The policy management program 102b is executed by the CPU 101 that cooperates with the memory 102 and the memory device 103, so that a policy management unit is implemented. Processing of the sensitive data detection program 102a and the policy management program 102b will be described in detail later.

### Configuration of Data Transfer Availability Information 102c According to First Embodiment

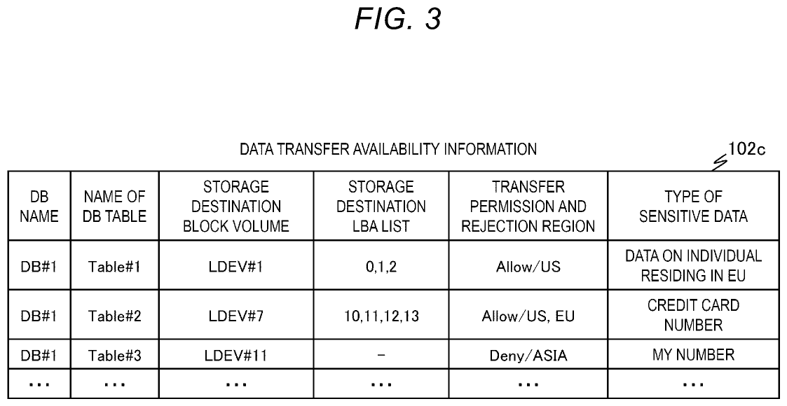

FIG. 3 is a diagram illustrating a configuration of the data transfer availability information 102c according to the first embodiment. The data transfer availability information 102c includes columns of “DB name”, “name of DB table”, “storage destination block volume”, “storage destination logical block addressing (LBA) list”, “transfer permission and rejection region”, and “type of sensitive data”.

The “DB name” indicates identification information on a database operating on the server 300. The “name of DB table” indicates identification information on a database table including sensitive data in each database operating on the server 300. The “storage destination block volume” indicates identification information on a block volume (may be simply referred to as a volume) of the storage apparatus 200 in which the DB table identified by the “DB name” and the “name of DB table” is stored. The DB table identified by the “DB name” and the “name of DB table” may be distributed and stored in a plurality of volumes.

The “storage destination LBA list” is a list of logical blocks (LBAs) in which the DB table including the sensitive data and identified by the “DB name” and the “name of DB table” is stored in the block volume. A database program running on the server 300 may provide a storage destination LBA of the DB table. Therefore, when the storage destination LBA is available, the “storage destination LBA list” can be provided in the data transfer availability information 102c. Alternatively, the “storage destination LBA list” may be omitted.

The “transfer permission and rejection region” indicates a country or region in which transfer of the DB table identified by the “DB name” and the “name of DB table” is permitted or rejected. The permission or rejection may be indicated by, for example, allow or deny or a flag. The “type of sensitive data” indicates a type of sensitive data that is included in the DB table identified by the “DB name” and the “name of DB table”.

The data transfer availability information 102c may be managed by being divided into, for example, information on “type of sensitive data” and “transfer permission and rejection region” and information on “DB name”, “name of DB table”, “storage destination block volume”, and “storage destination LBA list”.

### Configuration of Storage Apparatus 200 According to First Embodiment

As illustrated in FIG. 2, the storage apparatus 200 includes a CPU 201, a memory 202, a memory device 203, a front-end IF 204a, and a back-end IF 204b. The memory 202 stores a storage control program 202a, a data transfer program 202b, and storage site region information 202c.

The storage control program 202a is executed by the CPU 201 that cooperates with the memory 202 and the memory device 203, so that a storage control unit that controls the memory device 203 serving as a physical drive and that manages a memory area provided for the server 300 is implemented. The data transfer program 202b is executed by the CPU 201 that cooperates with the memory 202 and the memory device 203, so that a data transfer unit is implemented. Processing of the data transfer program 202b will be described in detail later.

The front-end IF 204a is an interface for the storage apparatus 200 to communicate with the policy management server 100 and the server 300 in an own site in which an own device is disposed. The back-end IF 204b is an interface for the storage apparatus 200 to communicate with another storage apparatus 200 in an own site in which an own device is disposed and the storage apparatus 200 disposed in another site using a protocol such as fiber channel (FC), internet small computer system interface (iSCSI), and Ethernet (registered trademark).

### Configuration of Storage Site Region Information 202c According to First Embodiment

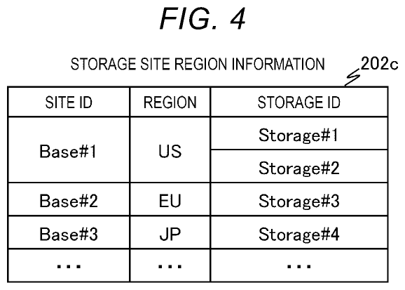

FIG. 4 is a diagram illustrating a configuration of the storage site region information 202c according to the first embodiment. The storage site region information 202c includes columns of “site ID”, “region”, and “storage ID”.

The “site ID” indicates identification information for identifying a site. The “region” indicates a country or region that is located with the site identified by the “site ID”. The “storage ID” indicates identification information for identifying a storage apparatus that is disposed at each site identified by the “site ID”.

### Data Transfer Availability Information Creation Processing According to First Embodiment

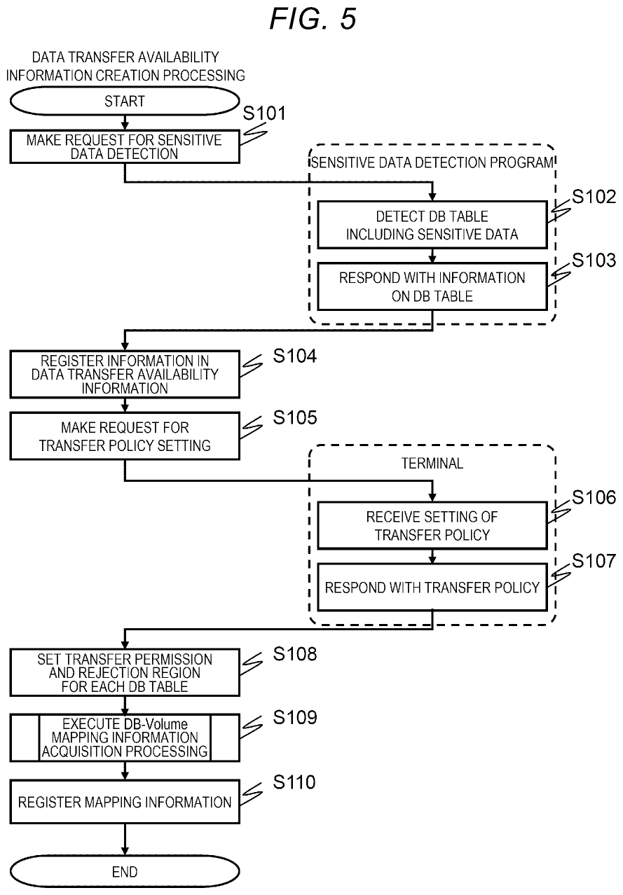

FIG. 5 is a flowchart illustrating data transfer availability information creation processing according to the first embodiment. The data transfer availability information creation processing is executed by the policy management server 100 with an instruction of the system administrator or a predetermined timing as a trigger. The data transfer availability information creation processing is executed before data transfer processing to be described later.

First, in step S101, the policy management program 102b requests the sensitive data detection program 102a to detect sensitive data from an own-site database.

Next, in step S102, the sensitive data detection program 102a detects the sensitive data from a DB table using a cloud service, a program to be operated on the server, or the like according to the request from the policy management program 102b.

Next, in step $103, the sensitive data detection program 102a responds to the policy management program 102b with “DB name”, “name of DB table”, and “type of sensitive data” of the DB table including the sensitive data detected in step S102.

Next, in step S104, the policy management program 102b registers, in the data transfer availability information 102c, the “DB name”, the “name of DB table”, and the “type of sensitive data” of the DB table including the sensitive data responded by the sensitive data detection program 102a in step S103. Next, in step S105, the policy management program 102b requests a data administrator or the system administrator to set a transfer policy including information on a transfer permission and rejection region for each DB table via a terminal (not illustrated) connected to the policy management server 100.

Next, in step S106, the terminal (not illustrated) connected to the policy management server 100 receives the setting of the transfer policy of the sensitive data detected in step S102, which is input by the system administrator. As the transfer policy, for example, a transfer permission and rejection region may be set for each DB table based on the type of sensitive data for the sensitive data included in the DB table. Alternatively, as a transfer policy, for example, a transfer permission and rejection region may be set for each of one or more pieces of sensitive data included in the DB table.

Next, in step S107, the terminal (not illustrated) connected to the policy management server 100 responds to the policy management program 102b with a transfer policy set in step S106 for each DB table or each piece of sensitive data.

Next, in step S108, the policy management program 102b sets the “transfer permission and rejection region” in the data transfer availability information 102c for each DB table or each piece of sensitive data according to the transfer policy serving as a response in step S107 for each DB table or each piece of sensitive data.

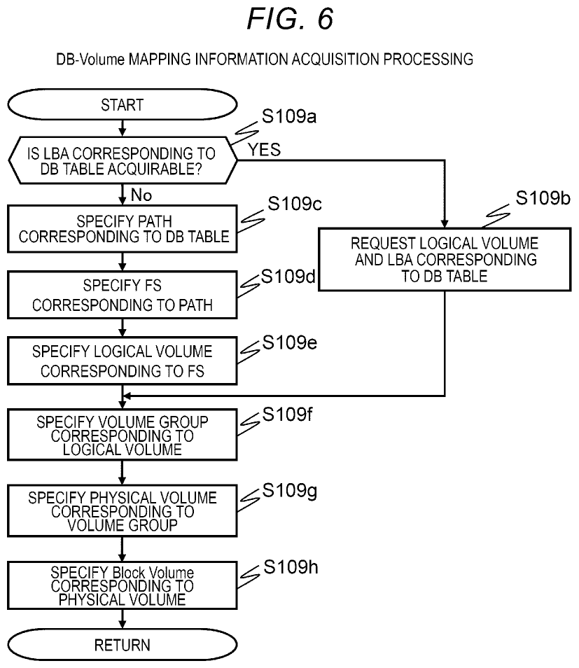

Next, in step S109, the policy management program 102b accesses the database server operating on the server 300 and executes DB-Volume mapping information acquisition processing that indicates a correspondence relationship between the DB table and the block volume. The DB-Volume mapping information acquisition processing will be described in detail later with reference to FIG. 6.

Next, in step S110, the policy management program 102b registers DB-Volume mapping information acquired in step S109 in the data transfer availability information 102c.

### DB-Volume Mapping Information Acquisition Processing According to First Embodiment

FIG. 6 is a flowchart illustrating the DB-Volume mapping information acquisition processing (step S109 in FIG. 5) according to the first embodiment.

First, in step S109a, the policy management program 102b determines whether an LBA corresponding to the “name of DB table” in the data transfer availability information 102c is acquirable (the storage apparatus 200 is a block storage). The policy management program 102b proceeds the processing to step S109b when the LBA is acquirable, and proceeds the processing to step S109c when the LBA is unacquirable.

In step S109b, the policy management program 102b requests, from a database server to be operated on the server 300, a logical volume and an LBA corresponding to the “DB name” and the “name of DB table” in the data transfer availability information 102c. When step S109b ends, the policy management program 102b proceeds the processing to step S109f.

In step S109c, the policy management program 102b requests the database server to be operated on the server 300 to specify a path (name of directory and file) corresponding to the “DB name” and the “name of DB table”. Next, in step S109d, the policy management program 102b requests a database management program to be operated on the server 300 to specify a file system (FS) corresponding to the path specified in step S109c. The FS is specified based on a root directory of the path specified in step S109c.

The database management program specifies a logical volume corresponding to the FS specified in step S109d in step S109e, specifies a volume group corresponding to the logical volume specified in step S109b or S109e in step S109f, specifies a physical volume corresponding to the volume group specified in step S109f in step S109g, and responds to the policy management program 102b.

Next, in step S109h, the policy management program 102b requests the storage control program 202a to be operated on the storage apparatus 200 specify the block volume corresponding to the physical volume specified in step S109g, and specifies the block volume.

### Data Transfer Processing According to First Embodiment

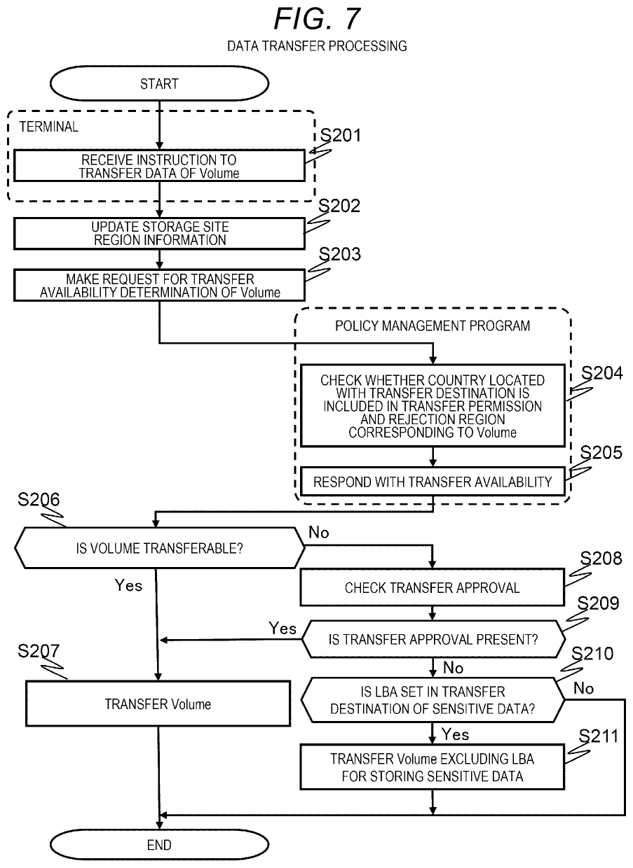

FIG. 7 is a flowchart illustrating the data transfer processing according to the first embodiment. The data transfer processing is executed by the storage apparatus 200 with an instruction of the system administrator or a predetermined timing (backup, remote replication creation, or the like) as a trigger.

First, in step S201, the data transfer program 202b receives input of an instruction to transfer the block volume, which is a transfer unit, by the system administrator via a terminal (not illustrated) connected to the storage apparatus 200 or the like. At this time, input of designation of a site ID of a transfer destination, a country or region located with the transfer destination, and a storage ID of the transfer destination is also received.

Next, in step S202, the data transfer program 202b updates the storage site region information 202c with the site ID of the transfer destination, the country or region located with the transfer destination, and the storage ID of the transfer destination, which are received in step S201. When regular transfer processing is performed on the same block volume, steps S201 and S202 can be omitted in the second and subsequent processing.

Next, in step S203, the data transfer program 202b requests the policy management program 102b of the policy management server 100 to determine whether the block volume for which a transfer instruction is received in step S201 is transferable to the site of the transfer destination.

Next, in step S204, the policy management program 102b of the policy management server 100 refers to the data transfer availability information 102c, and checks whether the country or region located with the transfer destination in step S202 is included in the “transfer permission and rejection region” in which the volume serving as a transfer availability determination target corresponds to the “storage destination block volume”.

Next, in step S205, the policy management program 102b responds to the data transfer program 202b whether the block volume to be transferred is transferable to the country or region located with the transfer destination input in step S202 according to a processing result of step S204.

Next, in step S206, the data transfer program 202b determines whether the response received from the policy management program 102b indicates that the block volume serving as the transfer availability determination target is transferable to the country or region located with the transfer destination. The data transfer program 202b proceeds the processing to step S207 when the block volume serving as the transfer availability determination target is transferable to the country or region located with the transfer destination (Yes in step S206), and proceeds the processing to step S208 when the block volume is untransferable (No in step S206).

In step S207, the data transfer program 202b transfers the block volume under the transfer instruction in step S201 to the storage apparatus at a site in the country or region located with a designated transfer destination. When step S207 ends, the data transfer program 202b ends the data transfer processing.

On the other hand, in step S208, the data transfer program 202b checks whether a transfer approval of the block volume under the transfer instruction in step S201 is input by the system administrator or a user via the terminal (not illustrated) connected to the storage apparatus 200. The data transfer program 202b proceeds the processing to step S207 when the transfer approval is input (Yes in step S209), and proceeds the processing to step S210 when the transfer approval is not input (No in step S209).

In step S210, the data transfer program 202b proceeds the processing to step S211 when whether the transfer destination is permitted or rejected for transfer and an LBA are registered in the block volume determined as untransferable in step S206, and ends the data transfer processing when the storage destination LBA is not set.

In step S211, the data transfer program 202b excludes an LBA for storing sensitive data from the block volume to be transferred, and transfers the block volume to be transferred to the storage apparatus at the site in the country or region located with the designated transfer destination.

The transfer excluding the LBAs in steps S210 and S211 may be executed without executing steps S208 and S209 and regardless of whether the transfer approval is present.

### Effects of First Embodiment

In the first embodiment, when a volume is transferred to a storage apparatus at a site located in another region of a transfer destination, data transfer availability information is referred to in which sensitive data and a transfer permission and rejection region of the sensitive data are associated with each other. Then, when DB data including the sensitive data is included in the volume, it is determined whether the transfer destination is included in the transfer permission and rejection region of the DB data indicated by the data transfer availability information. When the transfer destination of the volume is included in the transfer permission and rejection region of the DB data indicated by the data transfer availability information, it is determined to be transferable and the volume is transferred, and when the transfer destination is not included in the transfer permission and rejection region, it is determined to be untransferable and the transfer of the volume is prevented.

Therefore, according to the first embodiment, in a distributed storage system including a hybrid cloud environment or a multi-cloud environment, it is possible to implement data movement and replication complying with data governance.

### Modification of First Embodiment

In the first embodiment, in the data transfer processing (FIG. 7), a predetermined memory area unit instructed to transfer data in step S201 is a “block volume”. However, the predetermined memory area unit instructed to transfer data is not limited to the “block volume”, and may be any one of a “logical volume”, a “volume group”, and a “physical volume”.

For example, when the memory area unit instructed to transfer data is the “logical volume”, the processing is executed until step S109e in the DB-Volume mapping information acquisition processing (FIG. 6), and mapping information indicating a correspondence relationship between the DB table and the logical volume is acquired. In the data transfer availability information 102c (FIG. 3), the “logical volume” is stored instead of the “storage destination block volume” based on the acquired mapping information. The same also applies to the “volume group” and the “physical volume”.

### SECOND EMBODIMENT

In a second embodiment, a database is constructed in a file system provided by a file storage apparatus at a certain site, and transfer of the file system to another site is controlled according to whether a table of a database stored in the file system includes sensitive data.

On comparison, the second embodiment is the same as the first embodiment except that the storage apparatus 200 is a file storage and a data transfer unit from the storage apparatus 200 at a certain site to another site is a file or directory. In the second embodiment, description of the same parts as those in the first embodiment will be omitted, and differences will be mainly described.

### Configuration of Data Transfer Availability Information 102Bc According to Second Embodiment

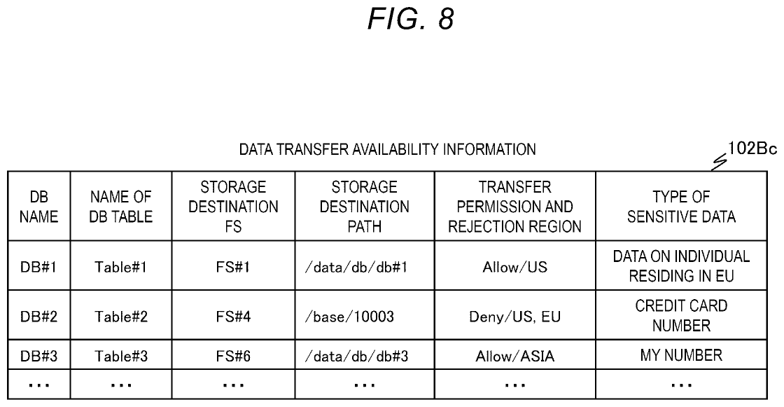

FIG. 8 is a diagram illustrating a configuration of data transfer availability information 102Bc according to the second embodiment. As compared with the data transfer availability information 102c (FIG. 3) according to the first embodiment, the data transfer availability information 102Bc according to the second embodiment includes a column of “storage destination FS” instead of the “storage destination block volume” and a column of “storage destination path” instead of the “storage destination LBA list”.

The “storage destination FS” indicates identification information on a file system (FS) in which a DB table identified by the “DB name” and the “name of DB table” is stored. Information on the “storage destination FS” is provided by a database program running on the server 300. The “storage destination path” indicates information for identifying a file path (name of directory and file) in which the DB table identified by the “DB name” and the “name of DB table” is stored in the FS identified by the “storage destination FS”.

### Data Transfer Availability Information Creation Processing According to Second Embodiment

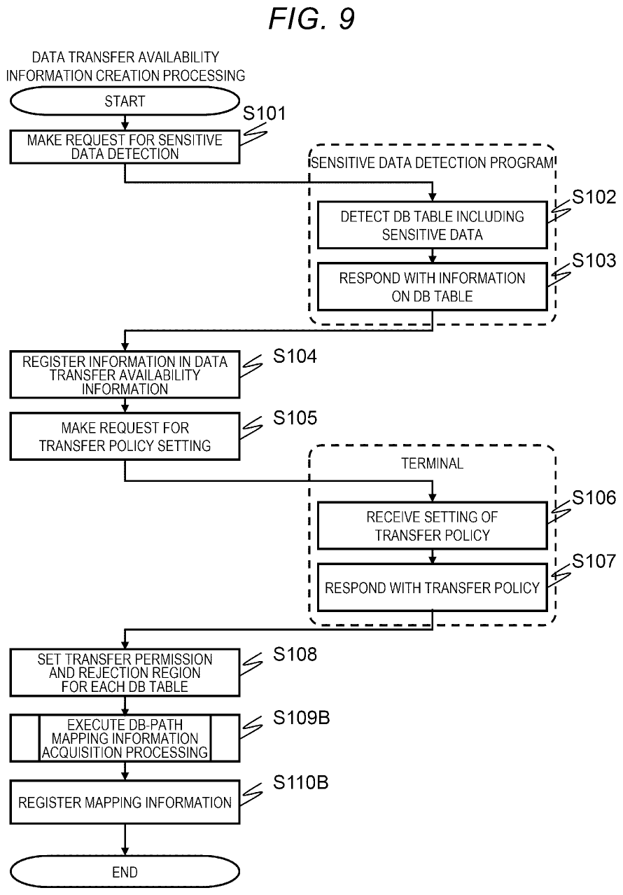

FIG. 9 is a flowchart illustrating data transfer availability information creation processing according to the second embodiment. As compared the data transfer availability information creation processing (FIG. 5) according to the first embodiment, the data transfer availability information creation processing according to the second embodiment is different in that steps S109B and S110B are executed instead of steps S109 and S110.

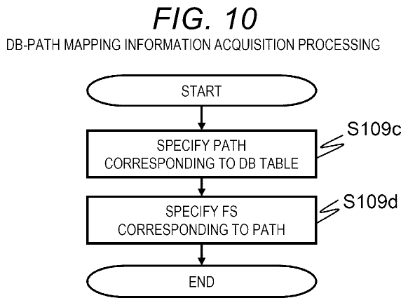

In step S109B, the policy management program 102b accesses a database server operating on the server 300, and executes DB-path mapping information acquisition processing that indicates a correspondence relationship between the DB table and the file path of the file system. The DB-path mapping information acquisition processing will be described in detail later with reference to FIG. 10.

Next, in step S110B, the policy management program 102b registers the DB-path mapping information acquired in step S109B in the data transfer availability information 102Bc.

### DB-Path Mapping Information Acquisition Processing According to Second Embodiment

FIG. 10 is a flowchart illustrating the DB-path mapping information acquisition processing according to the second embodiment. As compared with the DB-Volume mapping information acquisition processing (FIG. 6) according to the first embodiment, the DB-path mapping information acquisition processing according to the second embodiment is different in that only steps S109c and S109d are executed.

### Data Transfer Processing According to Second Embodiment

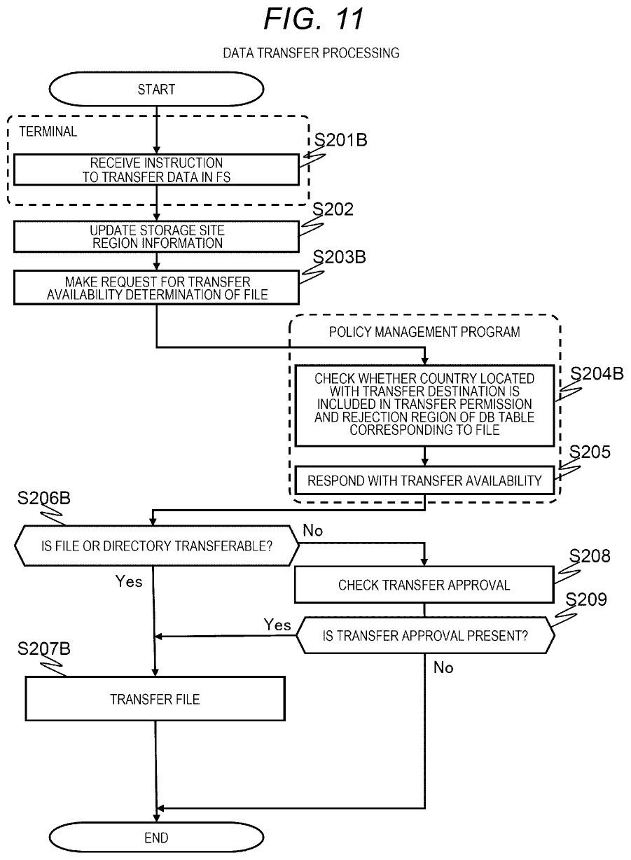

FIG. 11 is a flowchart illustrating data transfer processing according to the second embodiment. As compared with the data transfer processing (FIG. 7) according to the first embodiment, the data transfer processing according to the second embodiment is different in that steps S201B, S203B, S204B, S206B, and S207B are executed instead of steps S201, S203, S204, S206, and S207. In addition, as compared with the data transfer processing according to the first embodiment, the data transfer processing according to the second embodiment is different in that steps S210 and S211 are omitted and the data transfer processing ends when it is determined to be No in step S209.

In step S201B, the data transfer program 202b receives input of an instruction to transfer a file or a directory stored in the FS, which is a transfer unit, by a data administrator or a system administrator via a terminal (not illustrated) connected to the storage apparatus 200 or the like. At this time, input of designation of a site ID of a transfer destination, a country or region located with the transfer destination, and a storage ID of the transfer destination is also received.

In step S203B, the data transfer program 202b requests the policy management program 102b of the policy management server 100 to determine whether the file included in the FS for which a transfer instruction is received in step S201B is transferable to the site of the transfer destination.

In step S204B, the policy management program 102b of the policy management server 100 refers to the data transfer availability information 102Bc, and checks whether a country or region located with the transfer destination input in step S202 is included in a corresponding “transfer permission and rejection region” by setting each file included in the FS inquired from the data transfer program 202b as a “storage destination path”.

In step S206B, the data transfer program 202b determines whether a response received from the policy management program 102b indicates that each file or directory included in the FS inquired from the data transfer program 202b is transferable to the country or region located with the transfer destination. The data transfer program 202b proceeds the processing to step S207B for a file or directory (Yes in step S206B) that is transferable to the country or region located with the transfer destination, and proceeds the processing to step S208 for a file or directory (No in step S206B) that is untransferable to the country or region located with the transfer destination.

In step S207B, the data transfer program 202b transfers the transferable file or directory among files or directories included in the FS under the transfer instruction in step S201B to a storage apparatus at the site in the country or region located with a designated transfer destination. When step S207B ends, the data transfer program 202b ends the data transfer processing.

### Effects of Second Embodiment

In the second embodiment, since the storage apparatus 200 is a file storage that manages a DB table by a file path in units of file or directory, it is possible to perform transfer control in units of file in a manner of preventing transfer of untransferable files and transferring transferable files alone.

### THIRD EMBODIMENT

In a third embodiment, transfer of a file to another site is controlled according to whether file data stored in a file system provided by a file storage apparatus at a certain site includes sensitive data. The server 300 is a database server in the second embodiment. Alternatively, the server 300 is an application server (which may be constructed in either a physical server or a virtual server) of a type other than that of the database server in the third embodiment.

### Configuration of Data Transfer Availability Information 102Cc According to Third Embodiment

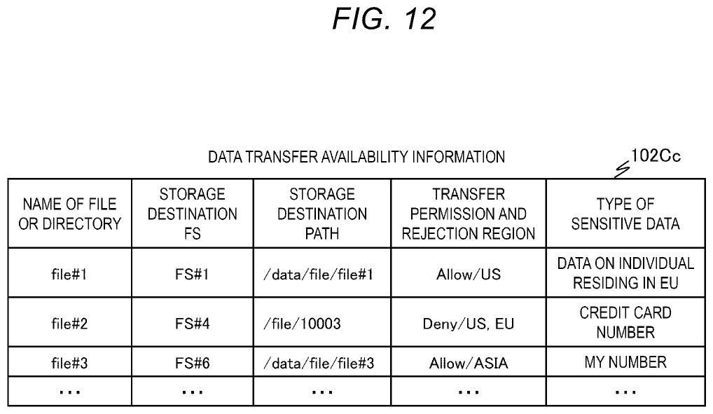

FIG. 12 is a diagram illustrating a configuration of data transfer availability information 102Cc according to the third embodiment. As compared with the data transfer availability information 102Bc (FIG. 8) according to the second embodiment, the data transfer availability information 102Cc according to the third embodiment omits the column of “DB name” and includes a column of “file name” instead of the “name of DB table”.

A “name of file or directory” indicates identification information on a file or directory including sensitive data in the file system provided by the storage apparatus 200. A “storage destination FS” indicates identification information on an FS in which the file identified by the “file name” is stored. A “storage destination path” indicates information for identifying a file path (name of directory and file) in which the file identified by the “file name” is stored in the FS identified by the “storage destination FS”.

### Data Transfer Availability Information Creation Processing According to Third Embodiment

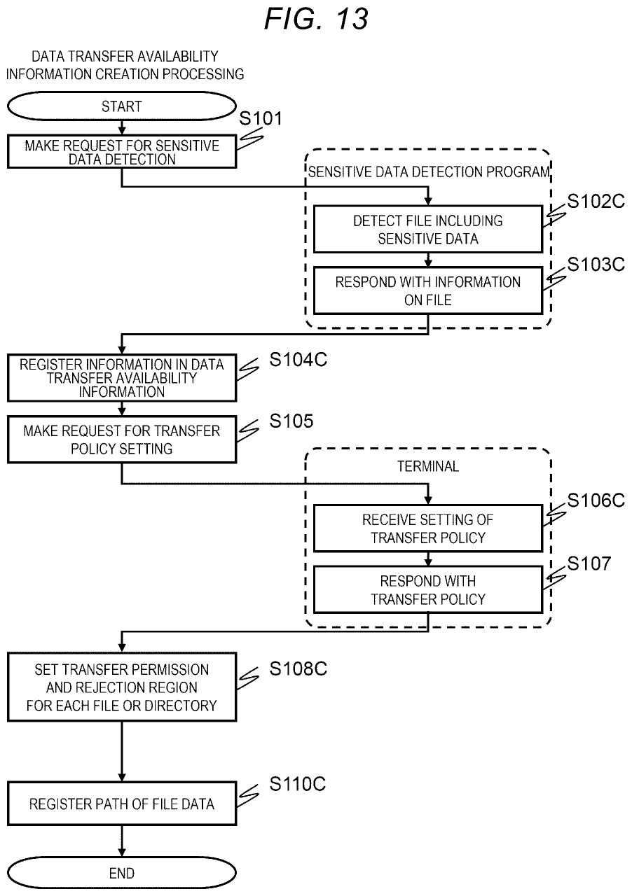

FIG. 13 is a flowchart illustrating data transfer availability information creation processing according to the third embodiment. As compared with the data transfer availability information creation processing (FIG. 9) according to the second embodiment, the data transfer availability information creation processing according to the third embodiment is different in that steps S102C, S103C, S104C, S106C, S108C, and S110C are executed instead of steps S102, S103, S104, S106, S108, and $110. In addition, as compared with the data transfer availability information creation processing (FIG. 9) according to the second embodiment, the data transfer availability information creation processing according to the third embodiment is different in that step S109B is not executed.

In step S102C, the sensitive data detection program 102a detects a file including sensitive data from the file system of the storage apparatus 200 according to a request from the policy management program 102b.

Next, in step S103C, the sensitive data detection program 102a responds to the policy management program 102b with the “file name” and the “type of sensitive data” of the file including the sensitive data detected in step S102C.

Next, in step S104C, the policy management program 102b registers, in the data transfer availability information 102Cc, the “file name” and the “type of sensitive data” of the file including the sensitive data responded by the sensitive data detection program 102a in step S103C.

In step S106C, a terminal (not illustrated) connected to the policy management server 100 receives setting of a transfer policy for each file including the sensitive data detected in step S102C or each piece of sensitive data, which is input by a data administrator or a system administrator.

In step S108C, the policy management program 102b sets a “transfer permission and rejection region” in the data transfer availability information 102c for each file or each piece of sensitive data according to the transfer policy serving as a response in step S107 for each file or each piece of sensitive data.

In step S110C, the policy management program 102b registers, in the data transfer availability information 102c, the file path of the file including the sensitive data responded by the sensitive data detection program 102a in step S103C.

### Data Transfer Processing According to Third Embodiment

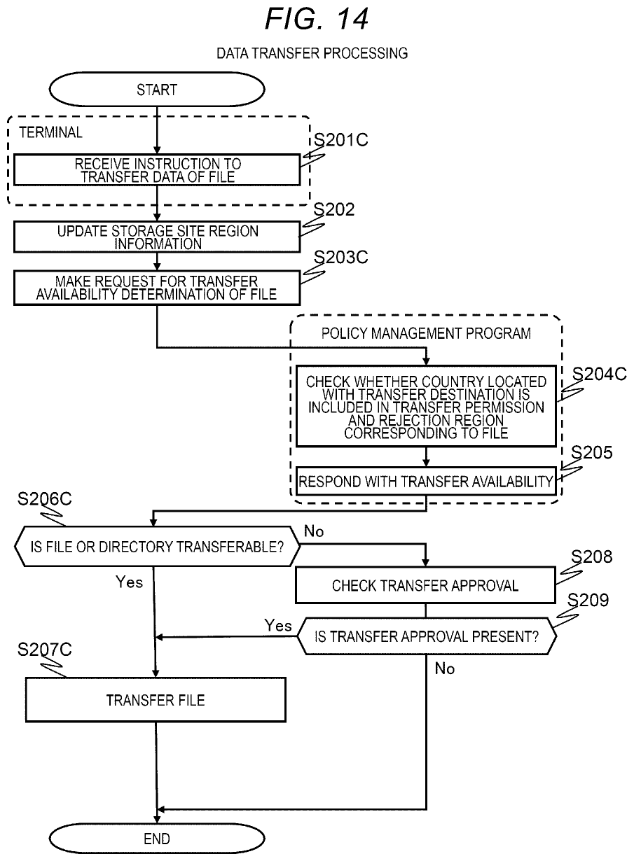

FIG. 14 is a flowchart illustrating data transfer processing according to the third embodiment. As compared with the data transfer processing according to the second embodiment (FIG. 11), the data transfer processing according to the third embodiment is different in that steps S201C, S203C, S204C, S206C, and S207C are executed instead of steps S201B, S203B, S204B, S206B, and S207B.

In step S201C, the data transfer program 202b receives input of an instruction to transfer a file or directory, which is a transfer unit, by the data administrator or the system administrator via a terminal (not illustrated) connected to the storage apparatus 200 or the like. At this time, input of designation of a site ID of a transfer destination, a country or region located with the transfer destination, and a storage ID of the transfer destination is also received.

In step S203C, the data transfer program 202b requests the policy management program 102b of the policy management server 100 to determine whether the file for which a transfer instruction is received in step S201C is transferable to the site of the transfer destination.

In step S204C, the policy management program 102b of the policy management server 100 refers to the data transfer availability information 102Cc, and checks whether a country or region located with the transfer destination input in step S201C is included in a corresponding “transfer permission and rejection region” by setting the file inquired from the data transfer program 202b as a “file name”.

In step S206C, the data transfer program 202b determines whether a response received from the policy management program 102b indicates that the file or directory inquired from the data transfer program 202b is transferable to the country or region located with the transfer destination. The data transfer program 202b proceeds the processing to step S207C when the file is transferable to the country or region located with the transfer destination (Yes in step S206C), and proceeds the processing to step S208 when the file is untransferable (No in step S206C).

In step S207C, the data transfer program 202b transfers the file under the transfer instruction in step S201C to the storage apparatus at a site in the country or region located with a designated transfer destination. When step S207C ends, the data transfer program 202b ends the data transfer processing.

### Effects of Third Embodiment

In the third embodiment, even if the server that performs data access on the storage apparatus 200 is an application server of a type other than that of the database server, it is possible to perform transfer control in units of file as in the second embodiment.

### Modifications of First to Third Embodiments

In the first to third embodiments, the storage apparatus 200 holds the storage site region information 202c in the memory 202. The storage site region information 202c may be held in the memory 102 of the policy management server 100 instead of the storage apparatus 200.

The data transfer availability information 102c, 102Bc, and 102Cc in the first to third embodiments may be displayed on a display connected to the policy management server 100 or the storage apparatus 200, or the like. Accordingly, the system administrator can directly refer to the data transfer availability information 102c, 102Bc, and 102Cc, determine whether target data is transferable to a transfer destination, and determine whether to perform or prevent transfer of the target data to the transfer destination according to a determination result.

Although the embodiments according to the invention are described in detail above, the invention is not limited to the above-described embodiments, and various modifications can be made without departing from the scope of the invention. For example, the above-described embodiments are described in detail for easy understanding of the invention, and the invention is not necessarily limited to those including all the configurations described above. A part of a configuration according to each above-described embodiment may be added, deleted, or replaced with another configuration.

Some or all of the above configurations, functional units, processing units, processing methods, and the like may be implemented by hardware by, for example, designing with an integrated circuit. In addition, each of the above configurations, functions, and the like may be implemented by software by a processor interpreting and executing a program for implementing each of the functions. Information on such as a program, a table, and a file for implementing each of the functions can be stored in a recording device such as a memory, a hard disk, or a solid state drive (SSD), or in a recording medium such as an IC card, an SD card, a DVD, or the like.

Each of the drawings described above shows control lines or information lines considered to be necessary for description, but does not necessarily show all control lines or information lines in a product. Actually, for example, it may be considered that almost all the configurations are connected to each other.

The above-described functions of the policy management server 100, the storage apparatus 200, and the server 300 and a data arrangement form are merely examples. The functions of the policy management server 100, the storage apparatus 200, and the server 300 and the data arrangement form may be changed to an optimum arrangement form from viewpoints of performance, processing efficiency, communication efficiency, and the like of the hardware or software provided therein.

For example, the sensitive data detection program 102a, the policy management program 102b, and the data transfer availability information 102c of the policy management server 100 may be held in the memory 202 of the storage apparatus 200, and the sensitive data detection program 102a and the policy management program 102b may be executed by the CPU 201 of the storage apparatus 200. The data transfer program 202b and the storage site region information 202c may be held in the memory 102 of the policy management server 100, and the data transfer program 202b may be executed by the CPU 101 of the policy management server 100.

A configuration (schema or the like) of a database that stores various types of data described above may be flexibly changed from viewpoints of efficient use of resources, improvement in processing efficiency, improvement in access efficiency, improvement in search efficiency, and the like.

What is claimed is:

1. A storage system including a storage apparatus for storing data, the storage system comprising:
a processor; and
a memory unit configured to store data transfer availability information in which sensitive data and a transfer permission and rejection region of the sensitive data are associated with each other, wherein
when receiving a transfer instruction to transfer a predetermined memory area unit stored in the storage apparatus to another storage apparatus located in another region different from a region located with the storage apparatus, the processor determines, with reference to the data transfer availability information, whether the other region serving as a transfer destination according to the transfer instruction is included in the transfer permission and rejection region that is associated with the sensitive data stored in the predetermined memory area unit according to the transfer instruction, and performs or prevents transfer of the predetermined memory area unit to the other storage apparatus according to a determination result of whether the other region is included in the transfer permission and rejection region.

2. The storage system according to claim 1, wherein
the processor acquires, from a server configured to access the sensitive data, information for specifying the predetermined memory area unit in which the sensitive data is stored, associates the transfer permission and rejection region associated with the sensitive data with the predetermined memory area unit in which the sensitive data is stored, and creates the data transfer availability information based on the information.

3. The storage system according to claim 2, wherein
when the storage apparatus is a block storage, the processor acquires the information from the server based on logical block addressing (LBA) in which the sensitive data is stored.

4. The storage system according to claim 1, wherein
when the predetermined memory area unit is untransferable to the other storage apparatus due to determination that the other region according to the transfer instruction is not included in the transfer permission and rejection region, the processor transfers the predetermined memory area unit to the other storage apparatus when a transfer approval is input by a user.

5. The storage system according to claim 1, wherein
the storage apparatus is a block storage, and
the predetermined memory area unit is a logical volume, a volume group, a physical volume, or a block volume of the storage apparatus.

6. The storage system according to claim 5, wherein
when the predetermined memory area unit is untransferable to the other storage apparatus due to determination that the other region according to the transfer instruction is not included in the transfer permission and rejection region, the processor determines whether a logical block addressing (LBA) is set as a storage destination of the sensitive data, and
when the LBA set, the processor transfers the is predetermined memory area unit excluding an LBA in which the sensitive data causing the predetermined memory area unit to be untransferable to the other storage apparatus is stored.

7. The storage system according to claim 1, wherein
the storage apparatus stores data accessed by a database server,
the sensitive data is included in a database table, and
the processor acquires, from the database server, information for specifying the predetermined memory area unit in which the database table is stored, associates the transfer permission and rejection region associated with the sensitive data with the predetermined memory area unit in which the database table is stored, and creates the data transfer availability information based on the information.

8. The storage system according to claim 1, wherein
the storage apparatus is a file storage, and
the predetermined memory area unit is a file system of the storage apparatus.

9. A data transfer control method executed by a storage system including a storage apparatus for storing data,
the storage system including a processor, and a memory unit configured to store data transfer availability information in which sensitive data and a transfer permission and rejection region of the sensitive data are associated with each other,
the data transfer control method comprising:
when receiving a transfer instruction to transfer a predetermined memory area unit stored in the storage apparatus to another storage apparatus located in another region different from a region located with the storage apparatus,
determining, by the processor with reference to the data transfer availability information, whether the other region according to the transfer instruction is included in the transfer permission and rejection region that is associated with the sensitive data stored in the predetermined memory area unit according to the transfer instruction; and
performing or preventing, by the processor, transfer of the predetermined memory area unit to the other storage apparatus according to a determination result of whether the other region is included in the transfer permission and rejection region.

10. A data transfer control program for executing data transfer control on data stored in a storage apparatus, the data transfer control program causing a computer to execute:
when receiving a transfer instruction to transfer a predetermined memory area unit stored in the storage apparatus to another storage apparatus located in another region different from a region located with the storage apparatus,
determining, with reference to data transfer availability information in which sensitive data and a transfer permission and rejection region of the sensitive data are associated with each other, whether the other region serving as a transfer destination according to the transfer instruction is included in the transfer permission and rejection region that is associated with the sensitive data stored in the predetermined memory area unit according to the transfer instruction; and
performing or preventing transfer of the predetermined memory area unit to the other storage apparatus according to a determination result of whether the other region is included in the transfer permission and rejection region.
